(19) United States
(12) Patent Application Publication
(10) Pub. No.: US 2010/0008576 A1
(43) Pub. Date: Jan. 14, 2010

(54) SYSTEM AND METHOD FOR SEGMENTATION OF AN IMAGE INTO TUNED MULTI-SCALED REGIONS

(76) Inventor: Robinson Piramuthu, Oakland, CA (US)

Correspondence Address: JONES DAY, 222 EAST 41ST ST, NEW YORK, NY, 10017, US

(21) Appl. No.: 12/502,125

(22) Filed: Jul. 13, 2009

Related U.S. Application Data
(60) Provisional application No. 61/079,908, filed on Jul. 11, 2008.

(51) Int. Cl. G06K 9/34

(52) U.S. Cl. 382/173

(57) ABSTRACT

Systems and methods for segmentation of an image into tuned multi-scale regions that comprise similarity in the pixels contained in each respective region. A watershed transform sub-process is performed upon an edge strength map of the image. A process for deriving an edge strength map may comprise preprocessing the image, extracting channels from the image, applying an edge operator to each channel, enhancing edge signal, normalizing the edge channels, combining the edge channels, and enhancing the signal to noise ratio for the channel. Once the watershed transform is complete, decisions on which neighboring regions to agglomerate may occur based on the cost effectiveness of the mergers. As desired, the boundaries for the regions created are resolved.

### CROSS REFERENCE TO RELATED APPLICATION

This application claims benefit, under 35 U.S.C. §119(e), of U.S. Provisional Patent Application No. 61/079,908, filed on Jul. 11, 2008, which is hereby incorporated by reference herein in its entirety.

### FIELD OF THE INVENTION

The field of this invention relates to systems and methods for segmenting digital images.

### BACKGROUND

With the advancement, ease of use, and decline of prices for digital cameras, the number of digital photographs and images taken throughout the world has increased substantially. Very often, the digital photographs and images are not completely satisfactory to the persons taking or viewing them. Indeed, many computer aided techniques exist to manipulate, retouch, or otherwise edit digital photographs and images.

Often the grouping of pixels that are spatially contiguous and have similar information within them can assist in the computer aided techniques, namely segmentation of the image. Segmentation of an image based on local properties and the associated creation of regions made up of locally coherent pixels has several applications in image processing and computer vision problems. Such regions maybe referred to as “JigCut regions” or “JigCuts.” JigCut regions or JigCuts can comprise any conventional type of regions created by segmentation of an image based on local properties, such as in the manner set forth in co-pending United States patent publication number US 20080247648 the application of which is assigned to the assignee of the present application and the respective disclosure of which is hereby incorporated by reference herein in its entirety.

Examples of this grouping, each of which is hereby incorporated by reference herein in its entirety, can be found in: “Watersheds in Digital Spaces: An Efficient Algorithm Based on Immersion Simulations,” Vincent L., Soille P., IEEE Transactions on Pattern Analysis and Machine Intelligence, Vol. 13, No. 6, pp. 583-598, June 1991; “Mean Shift: A Robust Approach Toward Feature Space Analysis,” Comaniciu D., Meer P., IEEE Tranactions on Pattern Analysis and Machine Intelligence, Vol. 24, No. 5, pp. 603-619, May 2002; “Normalized Cuts and Image Segmentation,” J. Shi, J. Malik, IEEE Transactions On Pattern Analysis and Machine Intelligence, Vol. 22, No. 8, pp 888-905, August 2000; “Learning a Classification Model for Segmentation,” X. Ren, J. Malik, ICCV 2003, Vol. 1, pp 10-17; “Clustering Appearance and Shape by Learning Jigsaws,” A. Kannan, J. Winn, C. Rother, NIPS 2006. An example of an application attempting to utilize this principle can be found in a product called FluidMask (Vertus; London, United Kingdom).

Unfortunately, each of the stated methods for segmenting an image into JigCut regions has drawbacks. For example, the Mean Shift method for partitioning an image may perform well, but does not give skeletonized region boundaries. Skeletonization is a popular binary morphological operation that reduces a binary image by eroding pixels away from at least one boundary, so that a skeletal image remains that preserves the extent and continuity of the original binary image. Direct application of the watershed transform generally over-partitions the image, though may provide for skeletonized region boundaries. The usage of Normalized Cut provides fewer total regions but lacks in performance speed. As should be apparent, there is a long-felt and unfulfilled need to provide improved systems and methods for performing the creation of JigCut regions without the weaknesses of previous applications.

### BRIEF DESCRIPTION OF DRAWINGS

The accompanying drawings, which are included as part of the present specification, illustrate the presently preferred embodiments and together with the general description and the detailed description of the embodiments given below serve to explain and teach the principles of the disclosed embodiments.

FIG. 1 is a top-level flow diagram for a method according to one embodiment for segmentation of an image into tuned multi-scale regions.

FIG. 2 is a top-level flow diagram of a method according to one embodiment for extracting an edge strength map from an image.

FIG. 3 is a top-level flow diagram of a method according to one embodiment for the agglomeration of neighboring regions based on similarity.

FIG. 4 is a sample color image illustrated in gray scale.

FIG. 5 is an exemplary image of Channel L for the sample color image of FIG. 4.

FIG. 6 is an exemplary image of Channel a for the sample color image of FIG. 4.

FIG. 7 is an exemplary image of Channel b for the sample color image of FIG. 4.

FIG. 8 is the sample image of Channel L from FIG. 5 after processing by the Sobel operator, with a range bar adjacent to illustrate the strength or weakness of the edges contained.

FIG. 9 is the sample image of Channel a from FIG. 6 after processing by the Sobel operator, with a range bar adjacent to illustrate the strength or weakness of the edges contained.

FIG. 10 is the sample image of Channel b from FIG. 7 after processing by the Sobel operator, with a range bar adjacent to illustrate the strength or weakness of the edges contained.

FIG. 11 is the sample image of Channel L from FIG. 8 after processing by a companding operator, with a range bar adjacent to illustrate the strength or weakness of the edges contained.

FIG. 12 is the sample image of Channel a from FIG. 9 after processing by a companding operator, with a range bar adjacent to illustrate the strength or weakness of the edges contained.

FIG. 13 is the sample image of Channel b from FIG. 10 after processing by a companding operator, with a range bar adjacent to illustrate the strength or weakness of the edges contained.

FIG. 14 is the sample image of Channel L from FIG. 1 after a normalizing sub-process, with a representative range bar set from 0 to 1.

FIG. 15 is the sample image of Channel a from FIG. 12 after a normalizing sub-process, with a representative range bar set from 0 to 1.

FIG. 16 is the sample image of Channel b from FIG. 13 after a normalizing sub-process, with a representative range bar set from 0 to 1.

FIG. 17 is a sample image illustrating the resulting edge strength map from combining the edge strength maps of Channel L, Channel a, and Channel b, represented in FIGS. 14-16, respectively.

FIG. 18 is the exemplary image of the edge strength map of FIG. 17 after processing by a noise removal sub-process and processing with a median filter.

FIG. 19 is the exemplary image of the edge strength map of FIG. 18 after processing for enhancing the signal values, namely, utilizing the Coherence Enhancing Diffusion.

FIG. 20 is an illustration of a watershed transform applied to the sample image of FIG. 4.

FIG. 21 is the edge strength map of FIG. 19 after processing via Otsu's approach.

FIG. 22 is an exemplary result of a watershed transform utilizing the edge strength map of FIG. 21.

FIG. 23 is the exemplary resulting image of FIG. 22 after agglomerating neighboring regions based on similarity at a lower level of coarseness.

FIG. 24 is the exemplary resulting image of FIG. 22 after agglomerating neighboring regions based on similarity at a higher level of coarseness.

FIG. 25 is the exemplary resulting image of FIG. 24 after the average color within each region is filled within each respective region.

FIG. 26 is the exemplary resulting image of FIG. 25 after the JigCut boundaries are resolved.

FIG. 27 is an illustration of an exemplary computer architecture for use with the present system, according to one embodiment.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present disclosure. The figures do not illustrate every aspect of the disclosed embodiments and do not limit the scope of the disclosure.

### DETAILED DESCRIPTION

A system for segmentation of an image into tuned multi-scaled regions and methods for making and using same is provided. In the following description, for purposes of explanation, specific nomenclature is set forth to provide a thorough understanding of the various inventive concepts disclosed herein. However it will be apparent to one skilled in the art that these specific details are not required in order to practice the various inventive concepts disclosed herein.

Some portions of the detailed description that follow are presented in terms of processes and symbolic representations of operations on data bits within a computer memory. These process descriptions and representations are the means used by those skilled in the data processing arts to most effectively convey the substance of their work to others skilled in the art. A process is here, and generally, conceived to be a self-consistent sequence of sub-processes leading to a desired result. These sub-processes are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

The disclosed embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a tangible computer readable storage medium, such as, but not limited to, any type of disk, including floppy disks, optical disks, CD-ROMS, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct more specialized apparatus to perform the required method sub-processes. The required structure for a variety of these systems will appear from the description below. In addition, the disclosed embodiments are not described with reference to any particular programming language. It will be appreciated that a variety of programming languages may be used to implement the teachings of the disclosed embodiments.

In some embodiments an image is a bitmapped or pixmapped image. As used herein, a bitmap or pixmap is a type of memory organization or image file format used to store digital images. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in Windows that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats, such as JPEG, TIFF, PNG, and GIF, to name just a few, in which the bitmap image (as opposed to vector images) is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics: Including C++, Laxmi Publications, p. 93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a greyscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2n colors) bitmap, in bytes, can be calculated as: size≈width×height×n/8, where height and width are given in pixels. In this formula, header size and color palette size, if any, are not included. Due to effects of row padding to align each row start to a storage unit boundary such as a word, additional bytes may be needed.

In computer vision, segmentation refers to the process of partitioning a digital image into multiple regions (sets of pixels). The goal of segmentation is to simplify and/or change the representation of an image into something that is more meaningful and easier to analyze. Image segmentation is typically used to locate objects and boundaries (lines, curves, etc.) in images.

The result of image segmentation is a set of regions that collectively cover the entire image, or a set of contours extracted from the image. Each of the pixels in a region share a similar characteristic or computed property, such as color, intensity, or texture. Adjacent regions are significantly different with respect to the same characteristic(s).

Several general-purpose algorithms and techniques have been developed for image segmentation. Exemplary segmentation techniques are disclosed in The Image Processing Handbook, Fourth Edition, 2002, CRC Press LLC, Boca Raton, Fla., Chapter 6, and Digital Image Processing, 1978, John Wiley & Sons, New York, Chapter 17 each of which is hereby incorporated by reference herein for such purpose. Since there is no general solution to the image segmentation problem, these techniques often have to be combined with domain knowledge in order to effectively solve an image segmentation problem for a problem domain.

In some embodiments, a segmentation technique used in accordance with the present invention is a watershed transform. See, for example, Roerdink and Meijster, 2001, Fundamenta Informaticae 41, 187-228, which is hereby incorporated by reference herein in its entirety. The watershed transform considers the gradient magnitude of an image as a topographic surface. Pixels having the highest gradient magnitude intensities (GMIs) correspond to watershed lines, which represent the region boundaries. Water placed on any pixel enclosed by a common watershed line flows downhill to a common local intensity minima (LMI). Pixels draining to a common minimum form a catchment basin, which represent the regions.

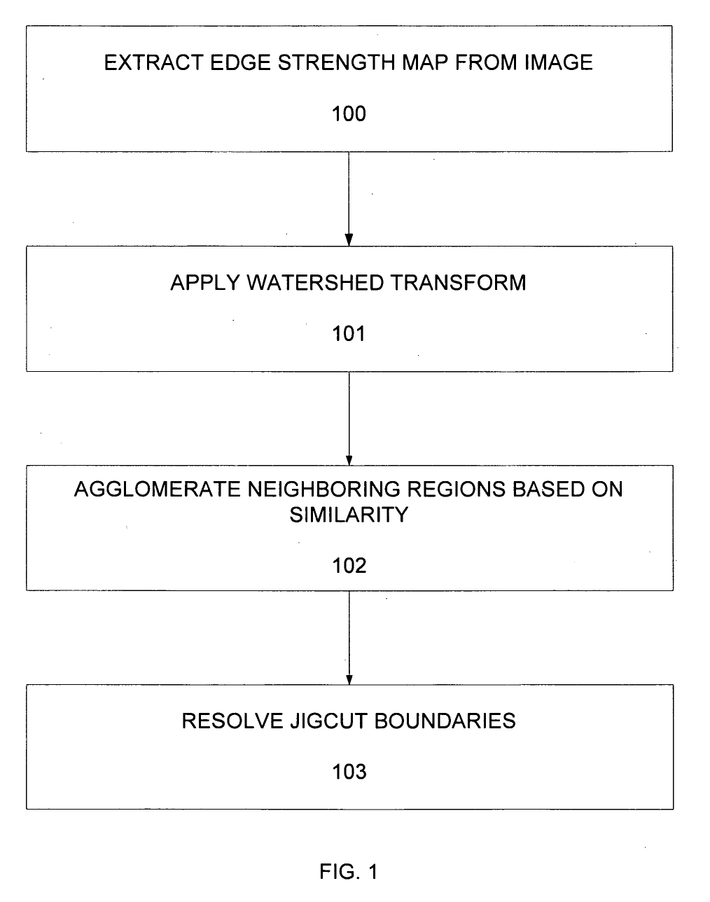

FIG. 1 is a top-level flow diagram for a method according to one embodiment for segmentation of an image into tuned multi-scale regions. At 100, an edge strength map is extracted from an image in some embodiments. Alternatively or additionally, an edge strength map for an image is provided or inputed. As disclosed below, the edge strength map is used for the process involving the segmentation of an image into tuned multi-scale regions, or JigCuts.

As illustrated in FIG. 1, 101 a watershed transform is applied to an edge strength map. As briefly described above, a watershed transform is a region-based segmentation approach. Given an edge strength map, it transforms the map into disjoint regions based on geographical arguments. Viewed as a topolgical landscape of the earth, water will naturally collect in lower plains, separated by ridges at higher levels. Water is said to collect in catchment basins, separated by watershed lines (or simply watersheds). In other words, the landscape is partitioned into basins by dams. The higher the dam, the more holding strength it possesses to prevent water from overflowing into the neighboring basin. This is analogous to an image being partitioned into locally similar regions that are separated by edges. The stronger the edge strength, the higher the region contrast.

In one embodiment, given an edge strength map, the watershed transform will provide an image where the catchment basins are assigned unique positive integer labels and the watershed pixels (or region boundary pixels) are assigned 0 (zero) labels. An advantageous feature of the watershed transform is that the boundaries are skeletionized by construction. As explained above, skeletonization is a binary morphological operation. The skeleton may be one pixel thick and may run through the medial axis of the object preserving its topology (properties such as extent or connectivity). It will be apparent that any method or system that will perform or produce the same functionally equivalent results from a watershed transform and/or skeletonization may be utilized to accomplish 101 of FIG. 1. There are several processes to achieve the watershed transform, such as the example mentioned above.

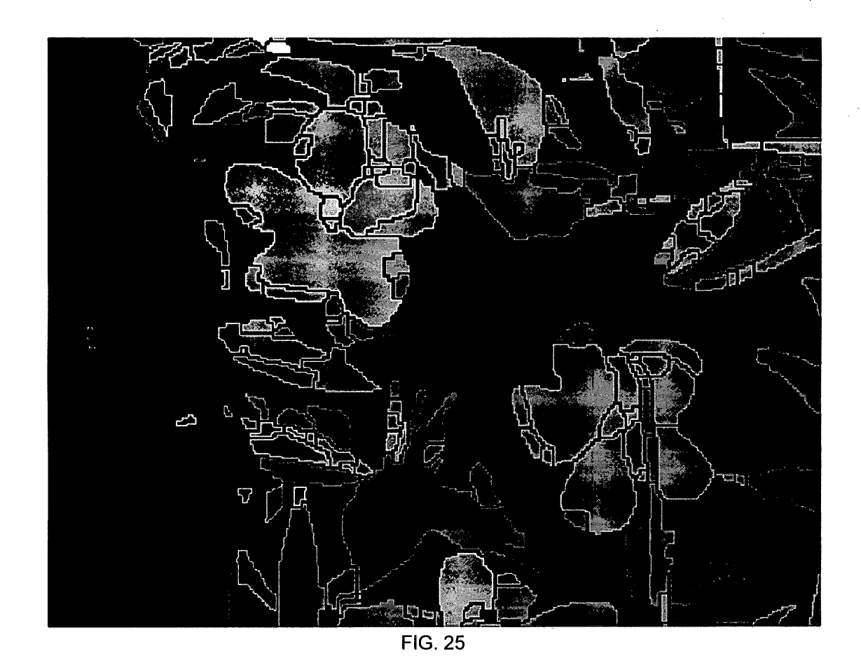

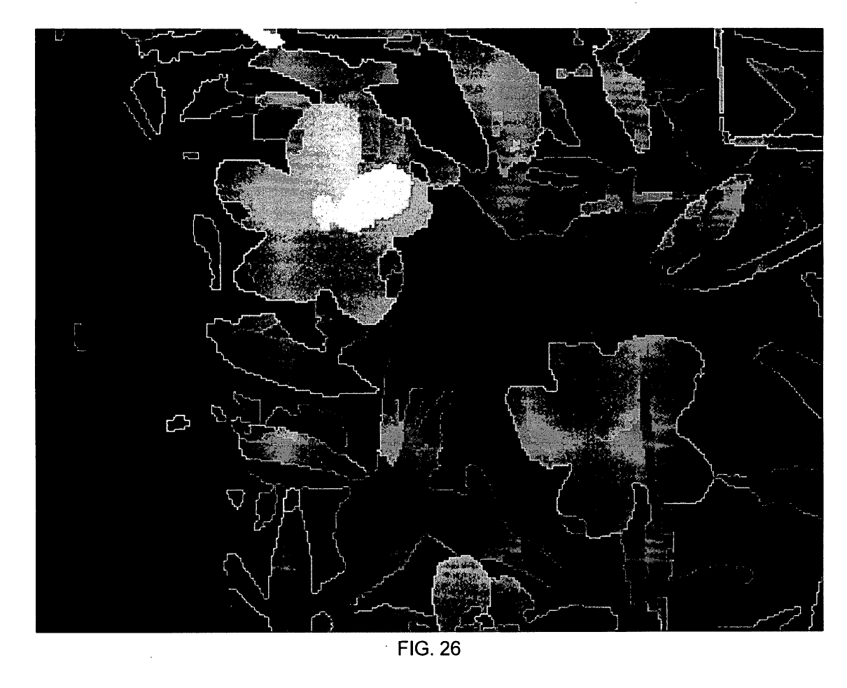

At FIG. 1, 102 neighboring regions are agglomerated based on similarity or other attributes. For example, in some embodiments the regions obtained from the watershed transform of an edge strength map are merged using rules, thresholds, and/or mathematical functions, or any combination thereof. As desired, in some embodiments, the boundaries of the JigCuts are resolved at 103. JigCut boundaries are useful for certain applications. When these boundaries are not required, they may be reassigned to one of the neighboring regions by utilizing any number of criteria. For example, one may utilize the nearest neighbor criterion in RGB space, where the average colors of neighboring regions are determined and the boundary pixel is assigned to the region with the closest average color. FIG. 26 is the exemplary resulting image of FIG. 25 after the JigCut boundaries are resolved.

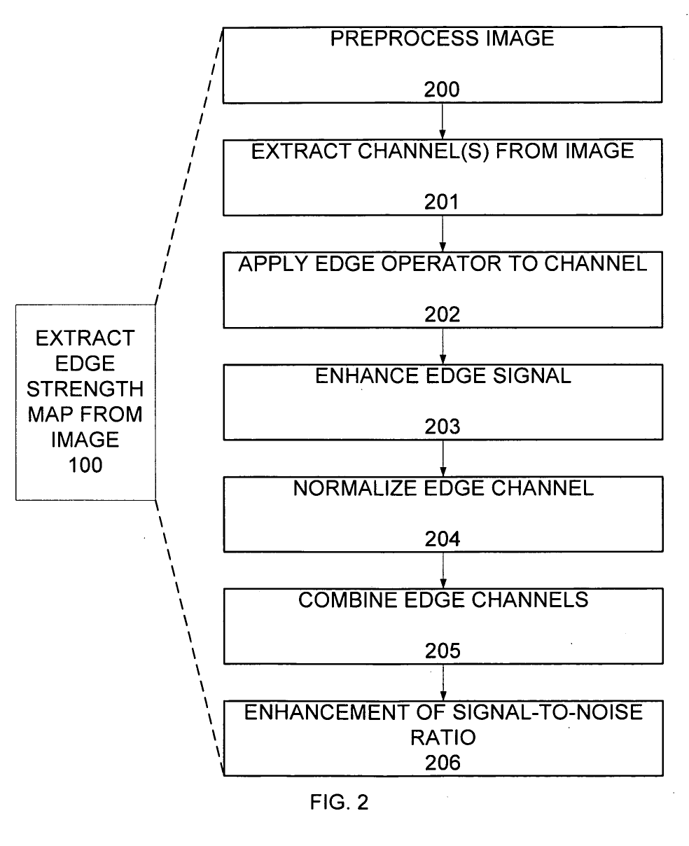

FIG. 2 is a top-level flow diagram of a method according to one embodiment for extracting an edge strength map from an image in accordance with one embodiment of FIG. 1, 100. An edge strength map may be created, obtained, or derived in numerous ways, processes, or methods. The embodiment illustrated in FIG. 2 serves as an exemplary method.

Edge detection is a term of art in image processing and computer vision, particularly within the areas of feature detection and feature extraction, that refers to algorithms aiming to identify points in a digital image at which the image brightness changes sharply or more formally has discontinuities.

The purpose of detecting sharp changes in image brightness is to capture important events and changes in properties of the world. It can be shown that under rather general assumptions for an image formation model, discontinuities in image brightness are likely to correspond to: discontinuities in depth, discontinuities in surface orientation, changes in material properties, and variations in scene illumination.

In the ideal case, the result of applying an edge detector to an image leads to a set of connected curves that indicate the boundaries of objects, the boundaries of surface markings as well curves that correspond to discontinuities in surface orientation. Thus, applying an edge detector to an image significantly reduces the amount of data to be processed and may therefore filter out information that may be regarded as less relevant, while preserving the important structural properties of an image in some embodiments. If the edge detection step is successful, the subsequent task of interpreting the information content in the original image may therefore be substantially simplified.

There are many methods for edge detection, many of which can be grouped into two categories, search-based and zero-crossing based. Search-based edge detection methods detect edges by first computing a measure of edge strength, usually with a first-order derivative expression such as the gradient magnitude, and then search for local directional maxima of the gradient magnitude using a computed estimate of the local orientation of the edge, usually the gradient direction. Zero-crossing based edge detection methods search for zero crossings in a second-order derivative expression computed from the image in order to find edges, usually the zero-crossings of the Laplacian or the zero-crossings of a non-linear differential expression, as will be described in the section on differential edge detection below. As a pre-processing step to edge detection, a smoothing stage, typically Gaussian smoothing, may be applied.

Known edge detection methods mainly differ in the types of smoothing filters that are applied and the way the measures of edge strength are computed. As many edge detection methods rely on the computation of image gradients, they also differ in the types of filters used for computing gradient estimates in the x- and y-directions.

As desired and illustrated in the exemplary method of FIG. 2, an image is optionally preprocessed 200. The decision on whether to preprocess may be based on the quality of the image. In some embodiments, preprocessing is desired when the image quality is poor. For example, there may be parts of image that are over-exposed or under-exposed, or the image may have low contrast regions which are of interest. To preprocess an image, a gamma correction, white point correction, or any other type of preprocess method or process for affecting the quality of the image, or any combination thereof, can be utilized.

In the embodiment illustrated in FIG. 2, one or more channels are optionally extracted from the image at 201. Optionally, the one or more channels are inputted or obtained for processing. The one or more channels may be any collection information from an image. For example, if the image has several different textures, then it may be beneficial to utilize texture channels and/or color channels. In some embodiments, the one or more channels are derived from any number of several color spaces. A color model is an abstract mathematical model describing the way colors can be represented as tuples of numbers, typically as three or four values or color components (e.g. RGB and CMYK are color models). However, a color model with no associated mapping function to an absolute color space is a more or less arbitrary color system with no connection to any globally-understood system of color interpretation. Adding a certain mapping function between the color model and a certain reference color space results in a definite “footprint” within the reference color space. This “footprint” is known as a gamut, and, in combination with the color model, defines a new color space. For example, ADOBE® RGB and sRGB are two different absolute color spaces, both based on the RGB model. Other examples of color spaces, without limitation, include, but are not limited to CIE, RGB, YIQ, YUV, HSV, and CMYK. Note that a single channel may also be utilized, for example, in a black and white image.

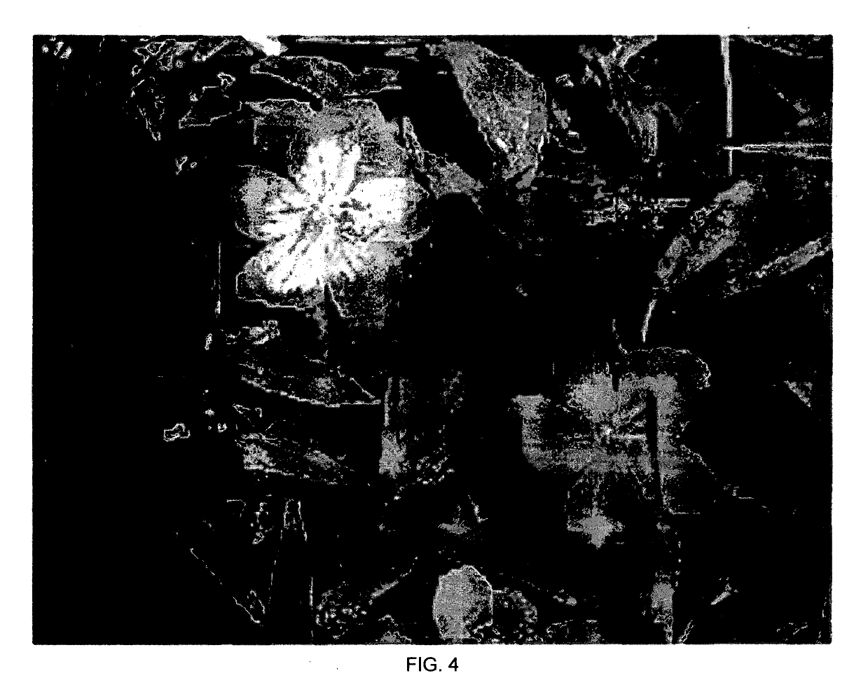

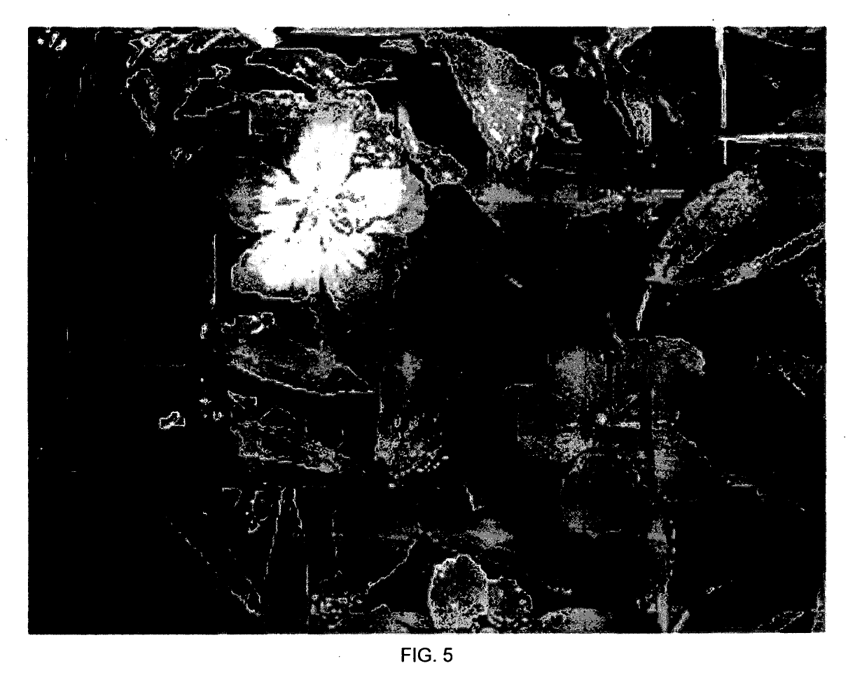

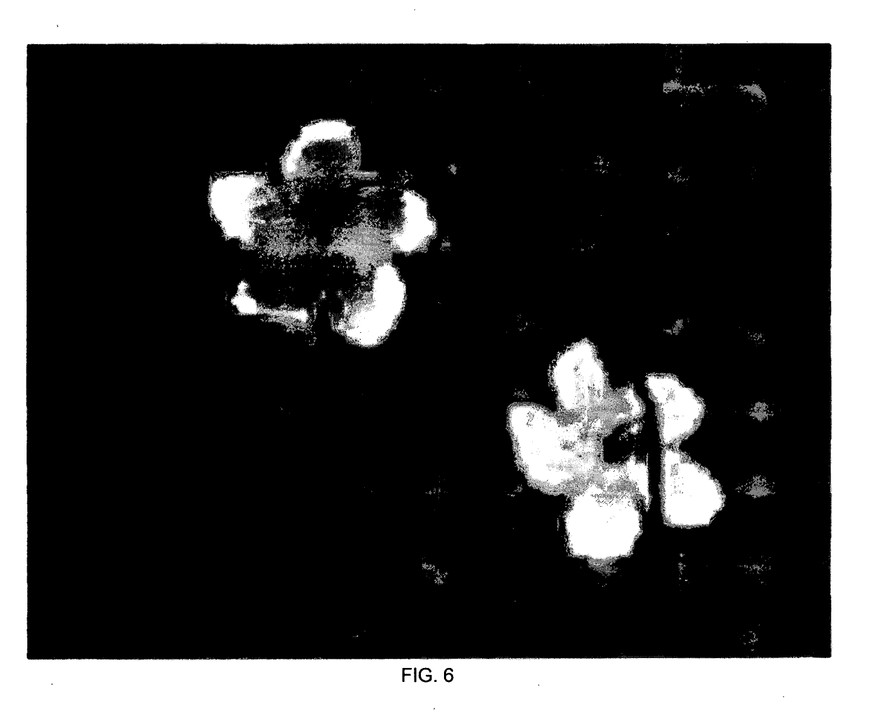

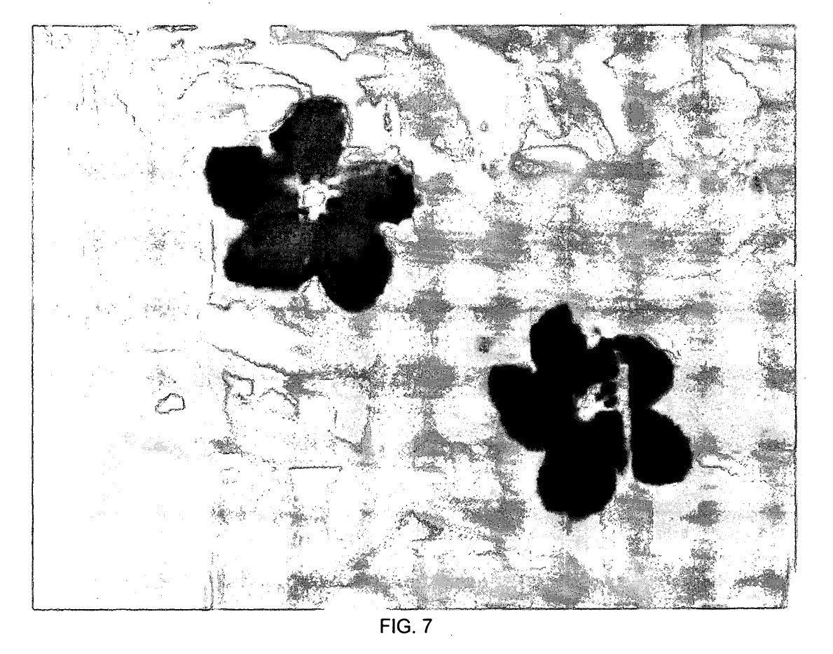

For example, the CIE-Lab color space, with the CIE standard illuminant D50, may be utilized. The CIE-Lab color space originated with perceptual uniformity in mind and D50 corresponds to a temperature of 5000 k (correlated to daylight). D50 is widely used in the printing industry. CIE-Lab consists of three channels: Channel L which is utilized to represent luminance; Channel a and Channel b, each of which represents color information. FIG. 4 is a sample color image illustrated in gray scale. Once this image is processed through the color space, channels for that space can be extracted. FIG. 5 is an exemplary image of Channel L for the sample color image of FIG. 4. FIG. 6 is an exemplary image of Channel a for the sample color image of FIG. 4. FIG. 7 is an exemplary image of Channel b for the sample color image of FIG. 4.

As illustrated in the exemplary embodiment of FIG. 2, at 202 an edge operator is optionally individually applied to each of one or more channels of information for an image in the selected color space. As desired, the edge operator is applied to each channel separately. A number of edge operators exist, and the use of any falls within the scope of this embodiment. In some embodiments, the edge operator has the ability to provide for edge strength.

For example, the Sobel operator may be utilized on one or more channels in 202. The Sobel operator is used in image processing, particularly within edge detection algorithms. Technically, it is a discrete differentiation operator, computing an approximation of the gradient of the image intensity function. At each point in the image, the result of the Sobel operator is either the corresponding gradient vector or the norm of this vector. The Sobel operator is based on convolving the image with a small, separable, and integer valued filter in horizontal and vertical direction and is therefore relatively inexpensive in terms of computations.

The Sobel operator may be utilized along rows of pixels and independently along the columns of pixels of an image. This is equivalent to taking the derivative of the image along y (vertical) and x (horizontal) directions respectively. The maximum of absolute values of these two derivatives is then used for each pixel. This is equivalent to taking the ∞-norm of the x and y derivatives (where ∞-norm of a finite collection of values is the maximum of absolute values).

The following formulas illustrate this operation:

$${S}_{x} = [ \begin{matrix}1 & 0 & - 1 \\ 2 & 0 & - 2 \\ 1 & 0 & - 1\end{matrix} ] , {S}_{y} = [ \begin{matrix}1 & 2 & 1 \\ 0 & 0 & 0 \\ - 1 & - 2 & - 1\end{matrix} ]$$

$${G}_{x} = I ⋆ {S}_{x} , {G}_{y} = I ⋆ {S}_{y}$$

$$G = max ( \vert {G}_{x} \vert , \vert {G}_{y} \vert )$$

where Sₓ represents the Sobel operator to extract edge strength along the horizontal direction of the channel, and S_{y} represents the Sobel operator to extract edge strength along the vertical direction. The image I is convolved with these filters to extract directional edge strengths Gₓ and G_{y}. The effective edge strength is represented by G.

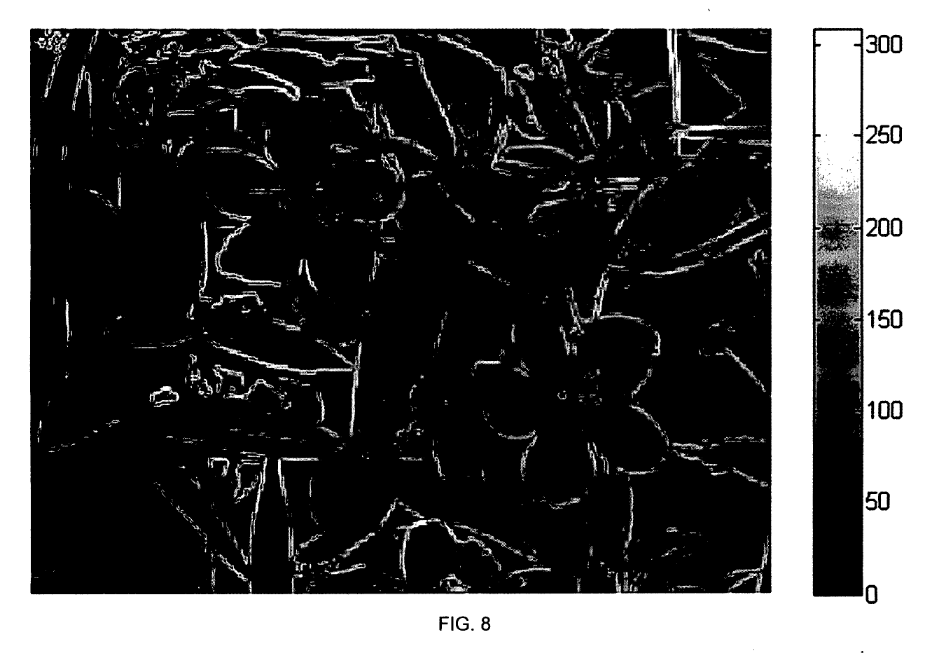

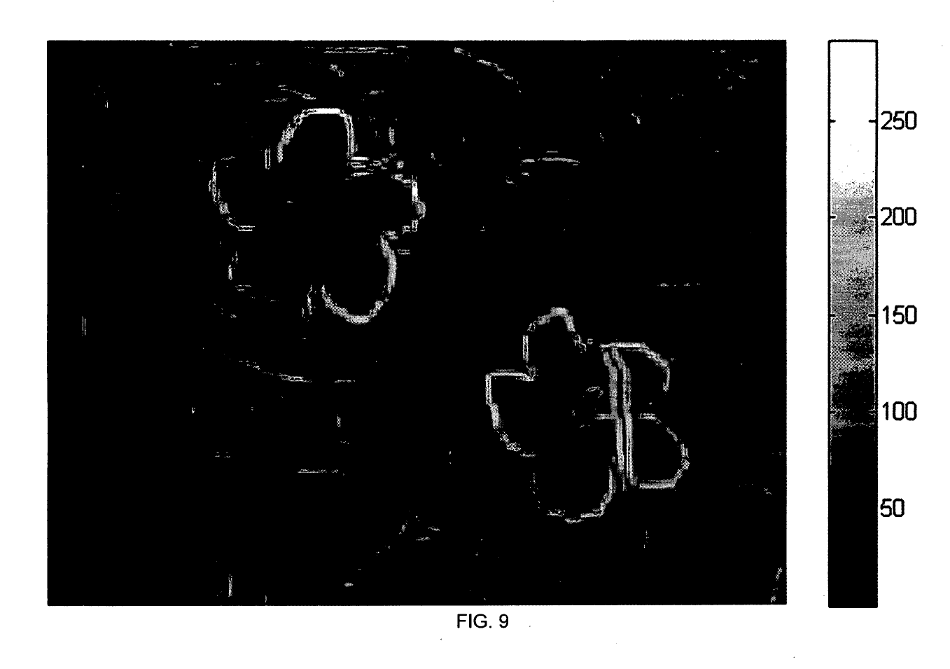

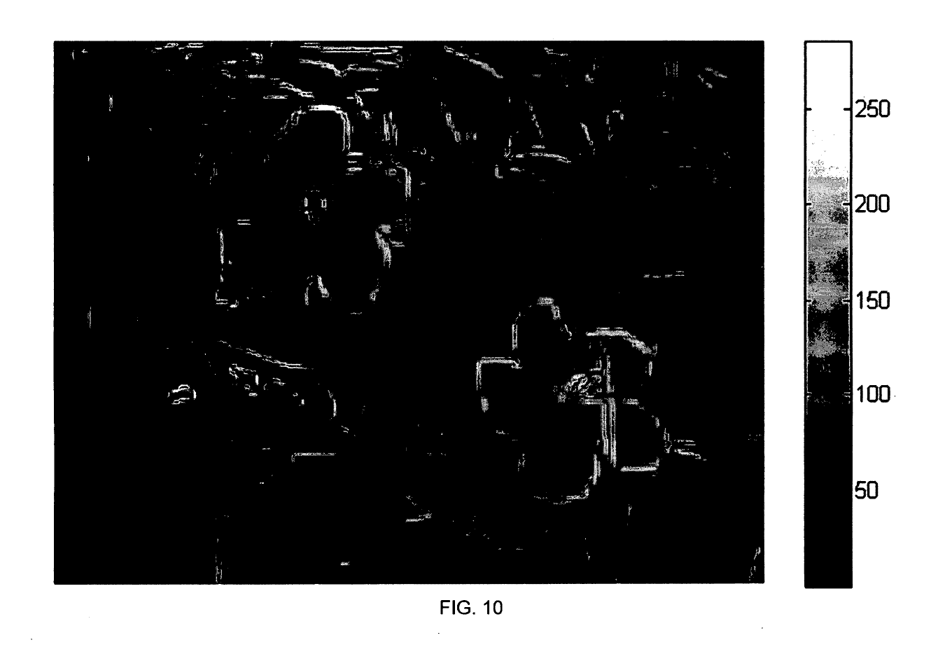

Because the result of the Sobel operator is a two-dimensional map of the gradient at each point, it can be processed and viewed as though it is itself an image, with the areas of high gradient (the likely edges) visible as white lines. FIG. 8 is the sample image of channel L from FIG. 5 after processing by the Sobel operator, with a range bar adjacent to illustrate the strength or weakness of the edges contained. FIG. 9 is the sample image of channel a from FIG. 6 after processing by the Sobel operator, with a range bar adjacent to illustrate the strength or weakness of the edges contained. FIG. 10 is a sample image of channel b from FIG. 7 after processing by the Sobel operator, with a range bar adjacent to illustrate the strength or weakness of the edges contained. The range bars illustrate the strength or weakness by the color of the edges found. For example, the edges represented by the brighter white are stronger edges than the edges represented by gray or dark gray.

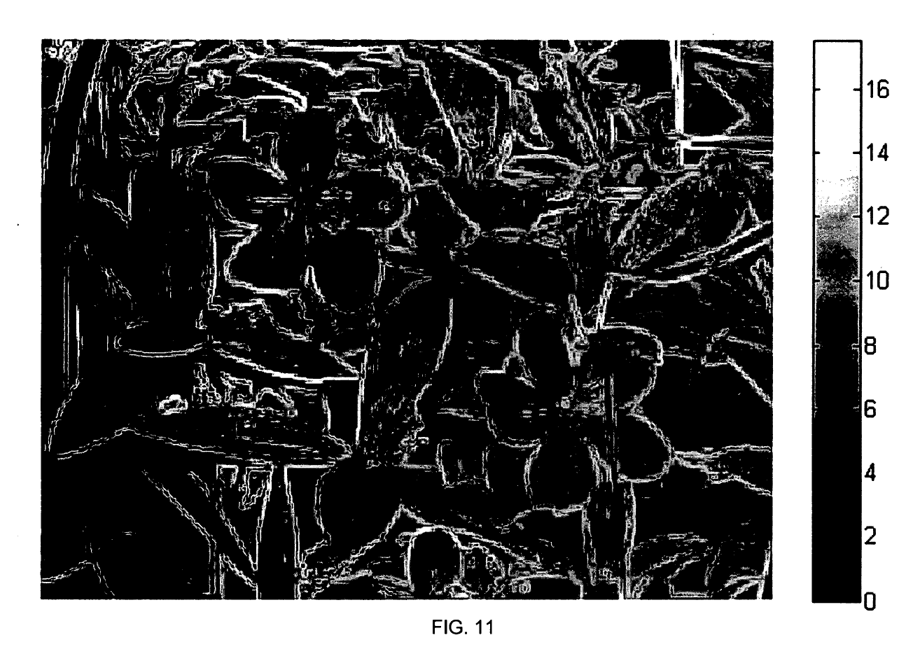

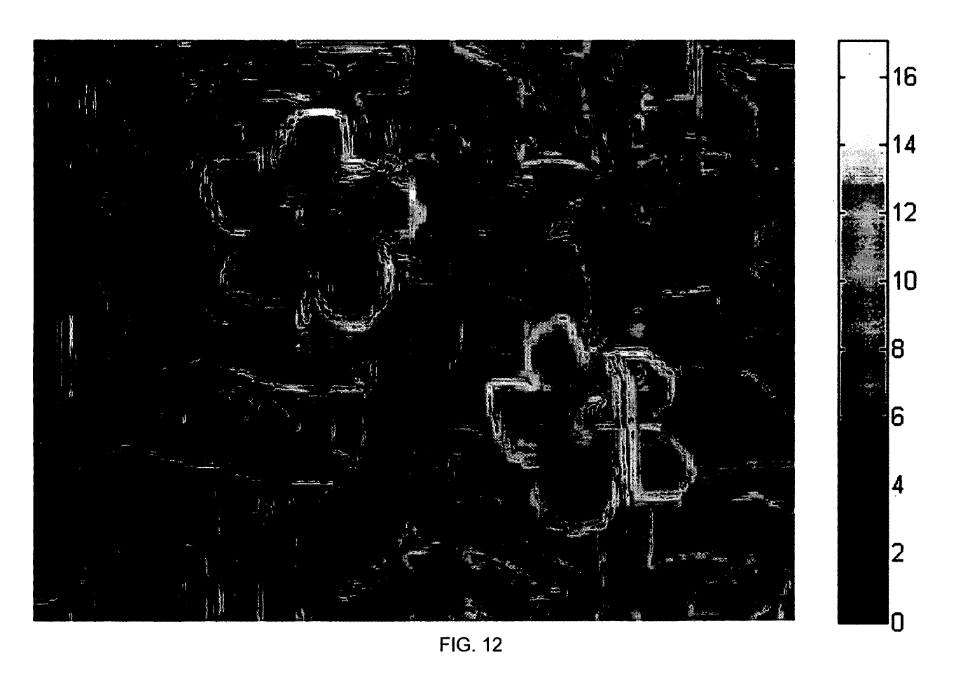

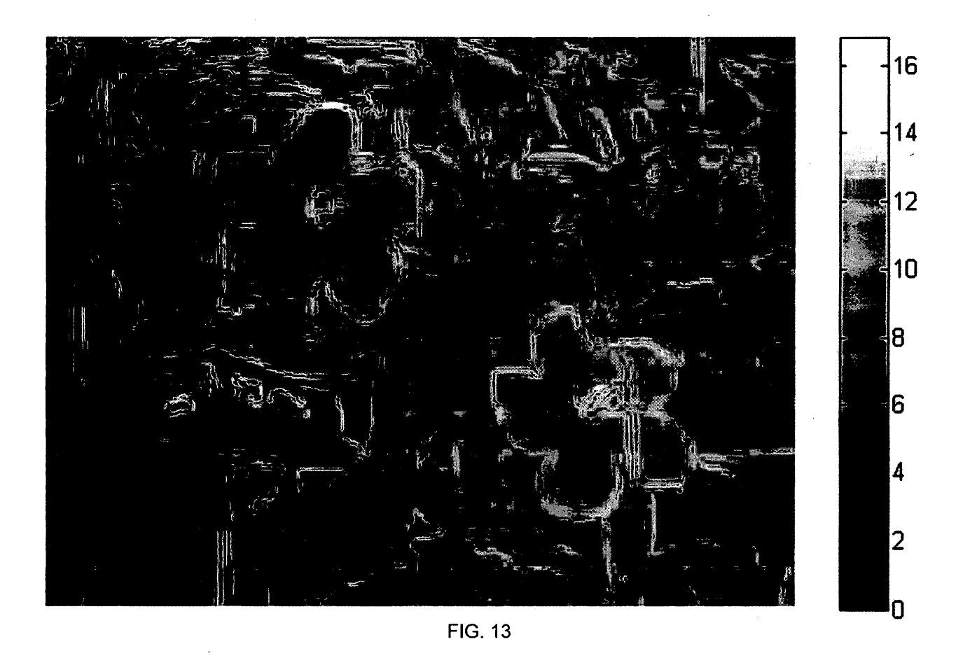

As desired and as illustrated in FIG. 2, the edges (or edge signals) of the channel or channels are optionally enhanced or processed 203. For example, in order to be sensitive to weak edges, the weak signals may need to be emphasized. Accordingly, edges with high strength may be compressed to a certain degree without losing edge details. Operators that achieve both of these sub-processes, and their equivalents, are referred to herein as companders or companding operators. Sqrt(.) is an example of such an operator since it stretches data in “low” ranges and compresses data in “high” ranges. In some embodiments, a companding operation comprises any conventional type of companding, such as in the manner set forth in Kaneko, “A Unified Formulation of Segment Companding Laws and Synthesis of Codecs and Digital Compandors,” Bell System Technical Journal 49, September 1970, pp. 1555-1558, which is hereby incorporated by reference herein in its entirety. FIG. 11 is the sample image of channel L from FIG. 8 after processing by a companding operator, with a range bar adjacent to illustrate the strength or weakness of the edges contained. FIG. 12 is the sample image of channel a from FIG. 9 after processing by a companding operator, with a range bar adjacent to illustrate the strength or weakness of the edges contained. FIG. 13 is the sample image of channel b from FIG. 10 after processing by a companding operator, with a range bar adjacent to illustrate the strength or weakness of the edges contained.

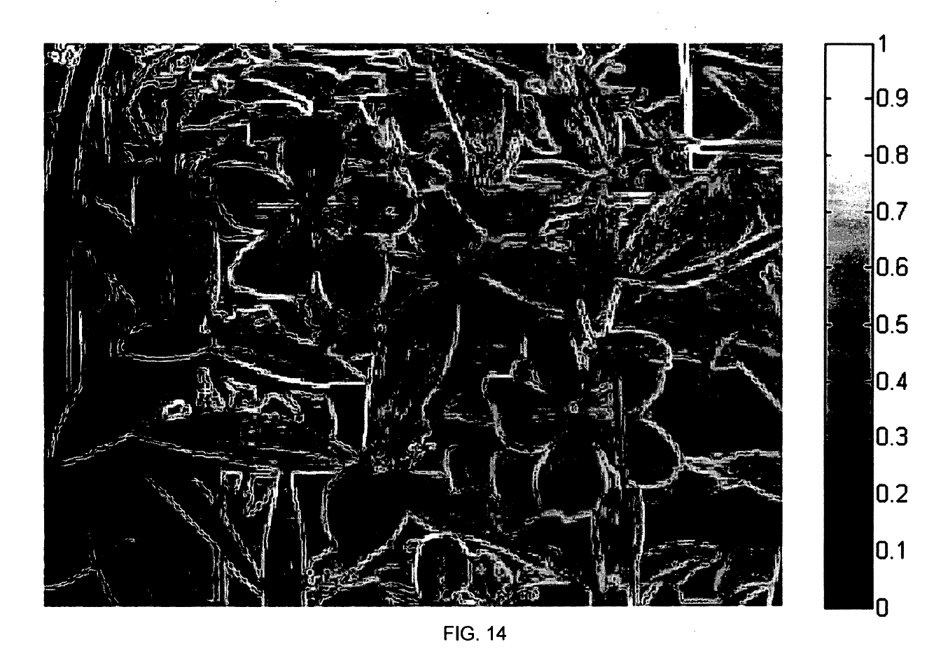

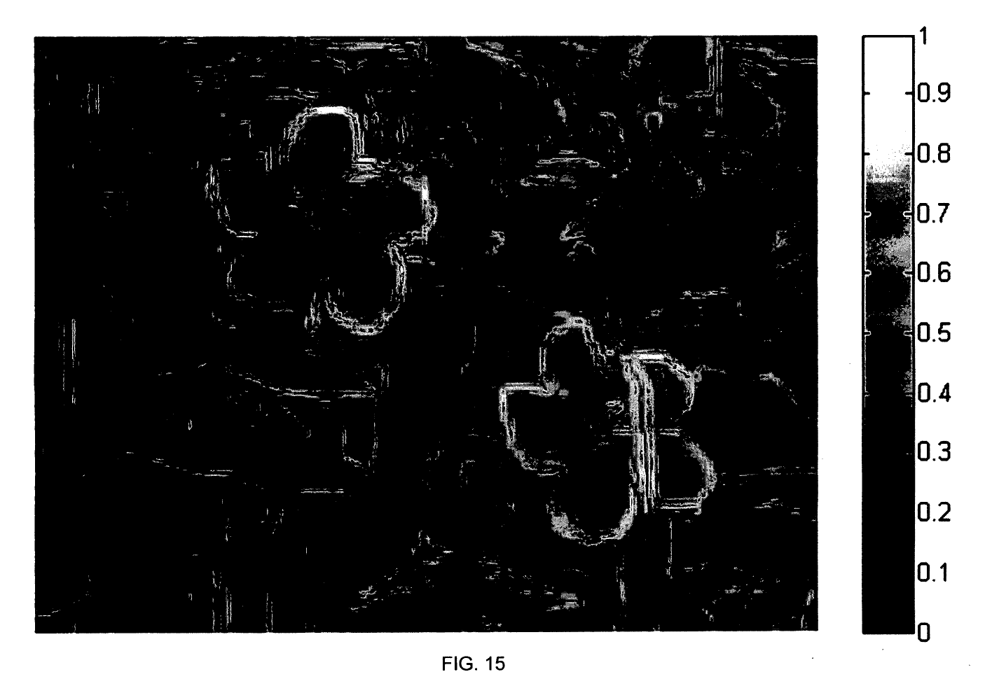

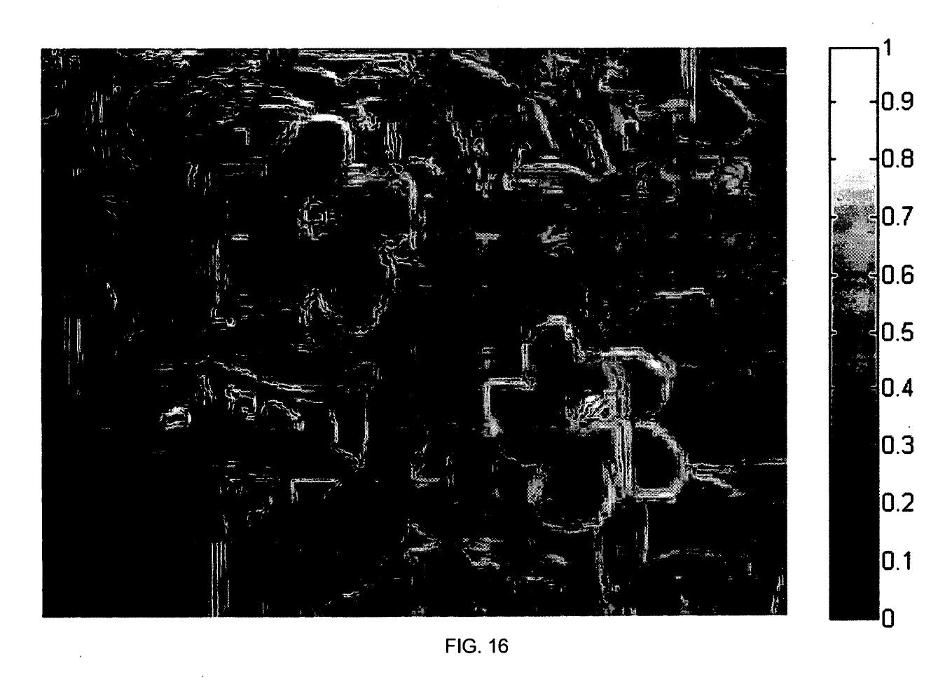

In an embodiment where more than one channel is utilized, the ranges for the channels may, as desired, be normalized 204. For example, the normalization may be set so the minimum value is 0 (zero) and the maximum value is 1 (one). FIG. 14 is the sample image of channel L from FIG. 11 after a normalizing sub-process, with a representative range bar that ranges from zero to one. FIG. 15 is the sample image of Channel a from FIG. 12 after a normalizing sub-process, with a representative range bar ranges from zero to one. FIG. 16 is the sample image of Channel b from FIG. 13 after a normalizing sub-process, with a representative range bar set that ranges zero to one.

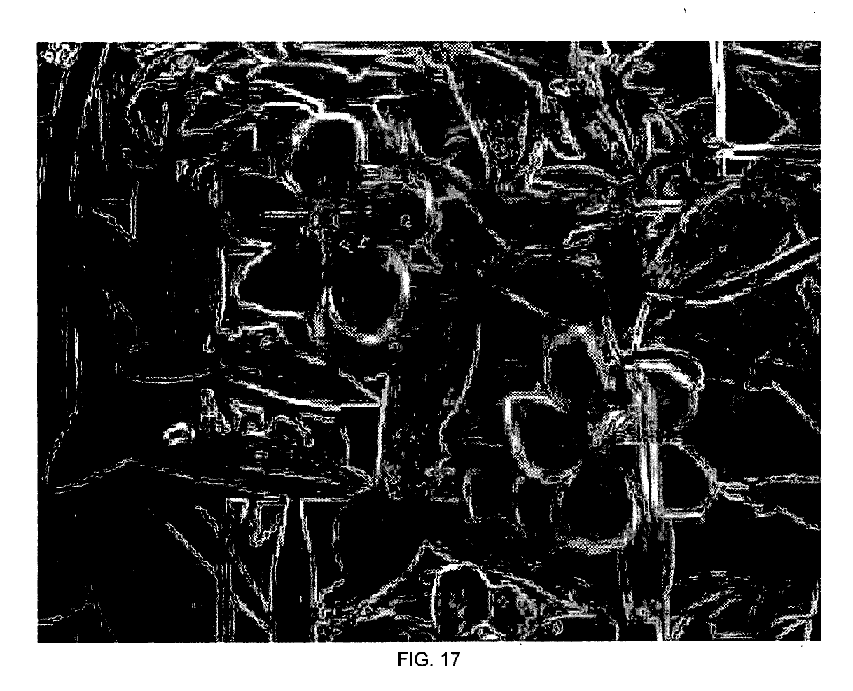

In an embodiment where more than one channel is utilized, the channels or selected channels may be 205 combined or collapsed together. In some embodiments, this is accomplished by viewing each pixel in each channel as a third dimensional vector holding edge information. In order to convert, combine, or collapse into a scalar, ∞-norm may be utilized, where ∞-norm of a finite collection of values is the maximum of absolute values. In other words, the maximum value of normalized edge strengths from each of the channel maps is utilized for each pixel. FIG. 17 is a sample image illustrating the resulting edge strength map from the combination of edge strength maps of channel L, channel a, and channel b, represented in FIGS. 14-16, respectively.

To remove or reject weak edges in the edge strength map, as desired, an enhancement of the signal-to-noise ratio is optionally performed on the edge strength map 206 (FIG. 2). The enhancement of the signal-to-noise ratio can comprise any conventional type of enhancement of signal-to-noise ratio, including but not limited to the following signal-to-noise ratio enhancement technique:
(1) Utilize Otsu' approach to classify a pixel as noise or not-noise based on its edge strength (See “A Thresholding Selection Method From Gray-Level Histogram,” N. Otsu, IEEE Transactions on System, Man and Cybernetics, Vol. 1, pp. 62-66, 1979, which is hereby incorporated by reference herein in its entirety);
(2) Processing the pixels classified as not-noise by a median filter (for example, a 3×3, or 5×5 median filter, where the value of a pixel is replaced by the median value of “signal” pixels in its neighborhood), for example, for a 3×3 neighborhood, the value of middle pixel is replaced by the median of the “signal” pixels among the surrounding 8 pixels; and/or
(3) Enhancement of the signal values or pixels based on local directionality of edges.
   Enhancing of signal values (3) can comprise any conventional type of enhancing signal values, including utilizing coherence enhancing diffusion as set forth in “Coherence-Enhancing Diffusion Filtering,” Weickert J., International Journal of Computer Vision. 31, No. 2/3, pp. 111-127, April 1999, which is hereby incorporated by reference herein in its entirety. The process setforth by Weickert provides for local eigen vectors utilized for an estimate of local directionality. Further, a diffusion tensor may then be derived from the average local directionality. This spatially variant filter may be repeated any number of times. To reduce computational burden, as desired, the diffusion tensor can be kept at a constant.

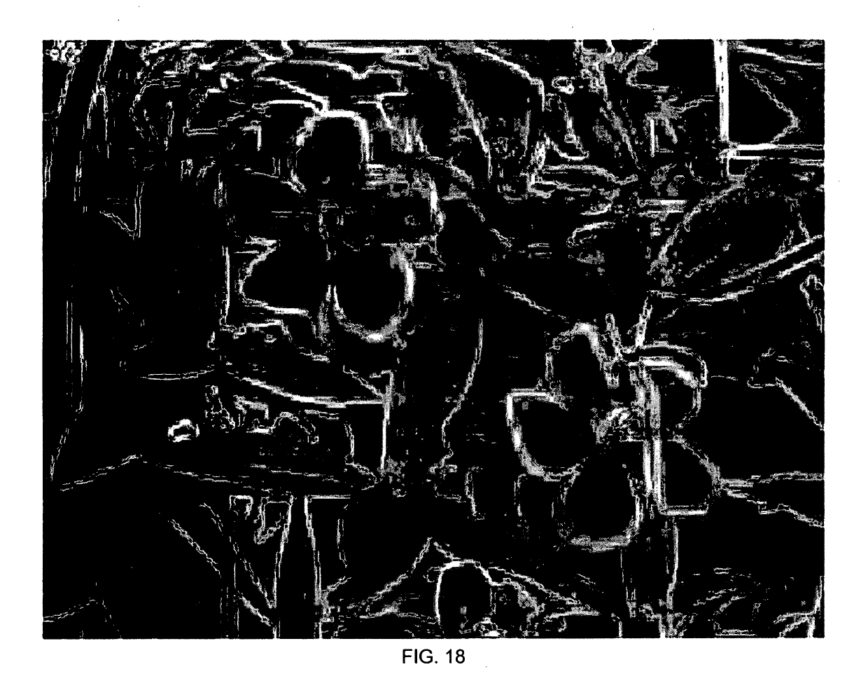

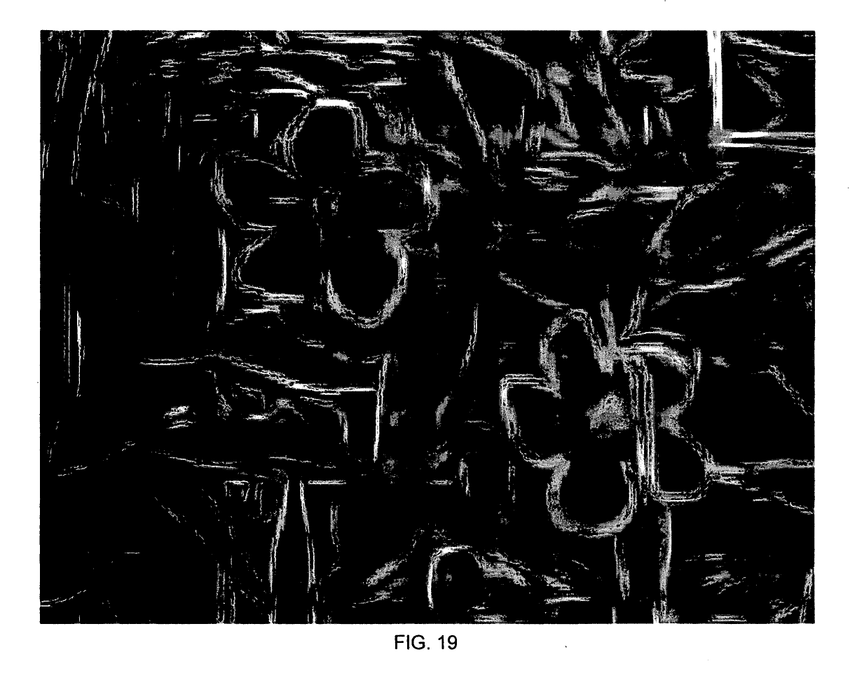

In some embodiments, before applying the coherence enhancing diffusion operation, a threshold is applied to reject weak edges. An advantageous aspect of utilizing the coherence enhancing diffusion is the ability to retain information about high contrast regions that are of interest and removing unwanted details. As a result, the number of JigCut regions may be reduced. FIG. 18 is an exemplary image of the edge strength map of FIG. 17 after processing by a noise removal sub-process and processing with a median filter. FIG. 19 is an exemplary image of the edge strength map of FIG. 18 after processing for enhancing the signal values, namely, utilizing the coherence enhancing diffusion.

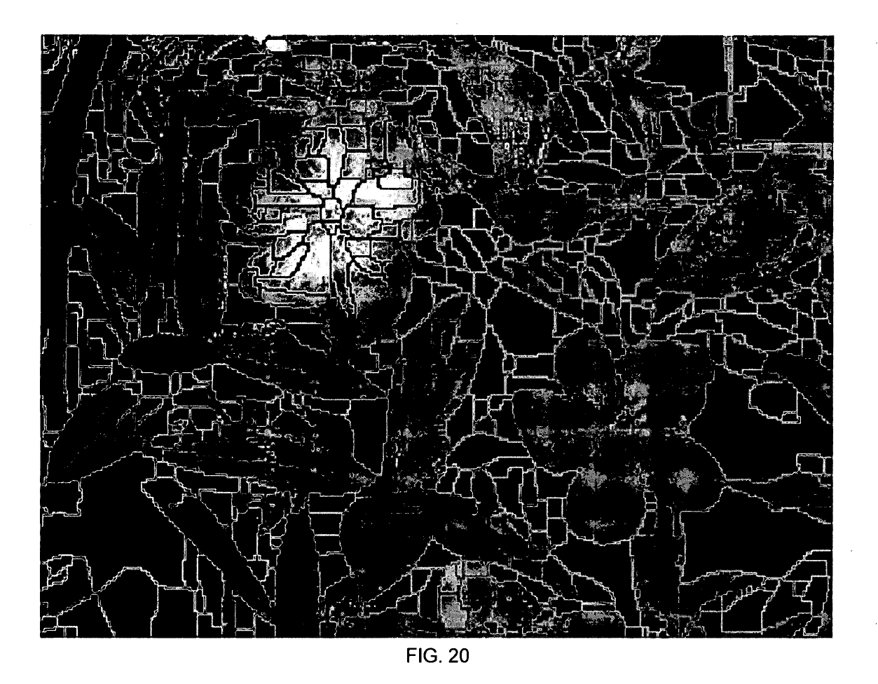

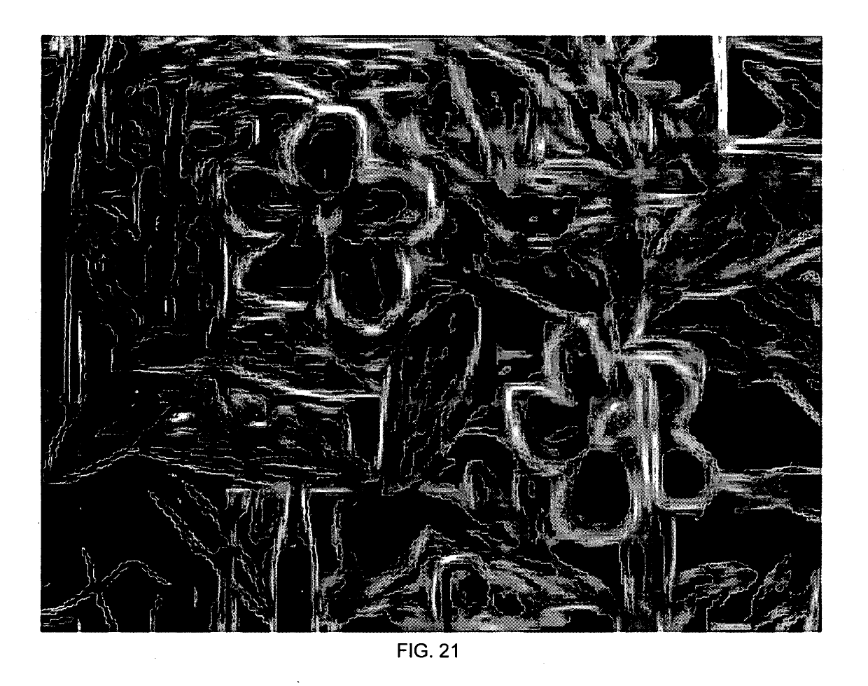

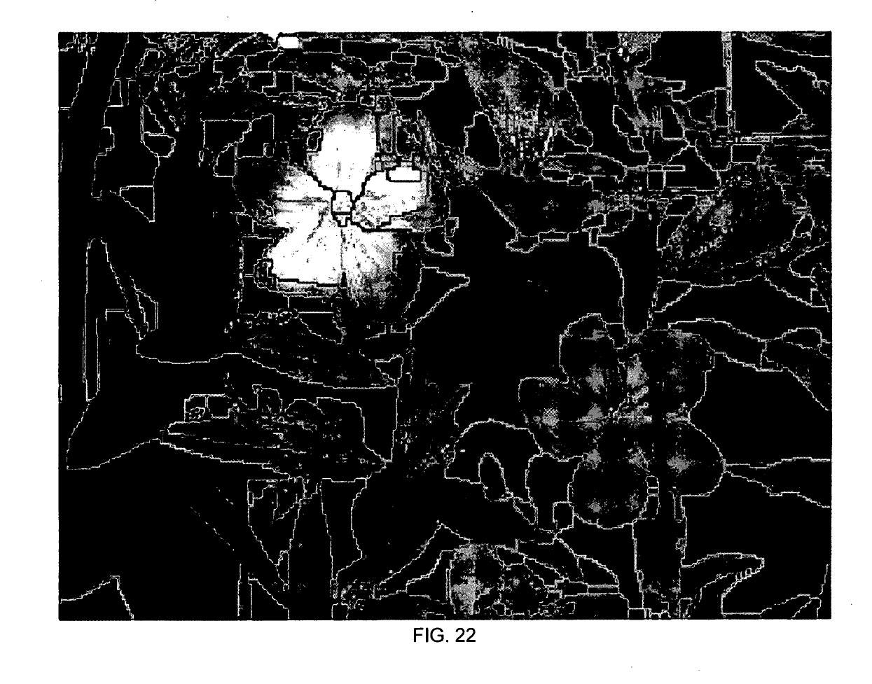

Returning to FIG. 1, as discussed above, a watershed transform may process, or be applied to, the edge strength map. In one embodiment, the watershed transform processes, or is applied to, the edge strength map after enhancement of signal-noise ratio 206. FIG. 20 is an illustration of a watershed transform applied to the sample image of FIG. 4. The original image in gray-scale is displayed with region boundaries in gray lines. It should be noted that the JigCut regions created by direct application of the watershed transform totaled to 833. In another embodiment, the edge strength map of FIG. 19 is processed by Otsu's approach to classify each pixel as noise or not-noise, and then the edge strengths for pixels deemed as noise are nullified. FIG. 21 is the edge strength map of FIG. 19 after processing via Otsu's approach. The edge strength map of FIG. 19 may then be processed by the watershed transform. FIG. 22 is an exemplary result of watershed transform utilizing the edge strength map of FIG. 21. The original image in gray-scale is displayed with the regions boundaries in gray lines. It should be noted that the JigCut regions created by applying the watershed transform to the edge strength map of FIG. 21 resulted in a total of 390 regions. As desired, the thresholds utilized in the sub-processes can be configured for higher or lower number of JigCut regions.

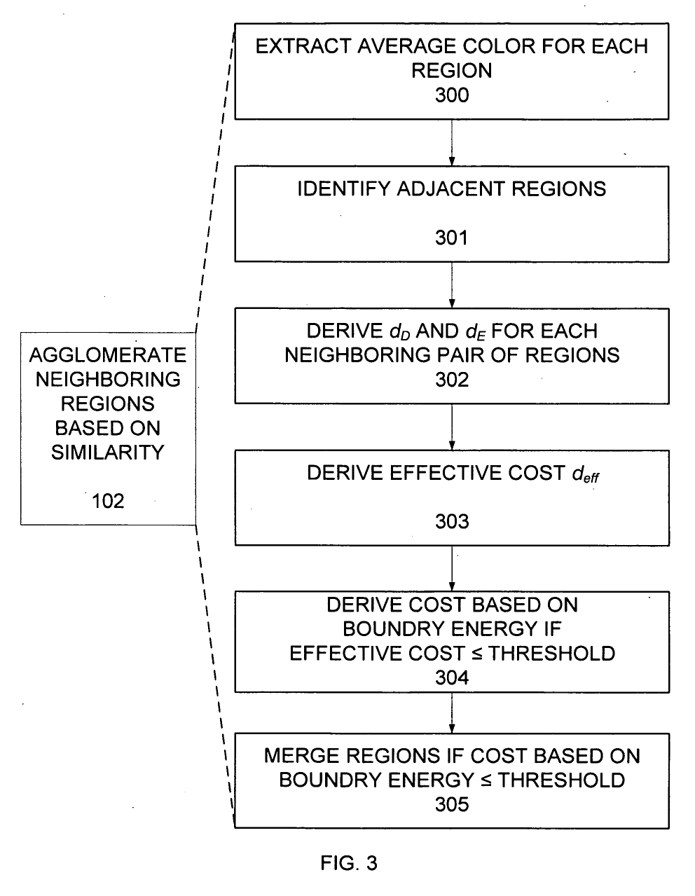

FIG. 3 is a top-level flow diagram of a method according to one embodiment for the agglomeration of neighboring regions based on similarity 102. The agglomeration or the merging of regions based on similarity can be viewed as a step that transverses the scale space in the coarser direction as explained in co-pending United States patent publication application 2008024768, which is hereby incorporated by reference herein in its entirety. Regions may be merged based on similarity in any of multiple different ways. In one embodiment, one or more different functions are utilized that provide for the costs (or scores) of merging the regions thereby allowing for the decision on whether the one or more regions should in fact be merged.

In another embodiment, the regions are merged by using three functions whose relative strengths in the mix are adjusted based on the iteration number. The integration weights form a sequence. The weights could be viewed as relaxation parameters that smoothly control when and how to execute different contraints.

In the exemplary embodiment illustrated in FIG. 3, the average color for each region is extracted or determined 300. Optionally, the average colors for each region is inputted or otherwise provided. In the RGB color space, a function for the average color may be described as:

fᵢ={avg.red, avg.green, avg.blue} for pixels in region i

where “avg.” stands for average. An identification of adjacent regions 301 may also occur. Optionally, information providing whether regions are adjacent may be derived, inputted, or provided.

The distance between distributions (d_{D}) and the cost of merging regions (d_{E}) may need to be determined for each neighboring pair of regions at 302. There are several processes for determining the distance between distributions. In mathematical analysis, distributions, also known as generalized functions, are objects that generalize functions and probability distributions. They extend the concept of derivative to all integrable functions and beyond, and are used to formulate generalized solutions of partial differential equations. They are useful for non-continuous problems that naturally lead to differential equations whose solutions are distributions, such as the Dirac delta distribution.

Two non-limiting exemplary approaches to determining the distance between distributions are Kullback-Leibler divergence and chi-squared error. In probability theory and information theory, the Kullback-Leibler divergence is a non-commutative measure of the difference between two probability distributions P and Q. Kullback-Leibler measures the expected difference in the number of bits required to code samples from P when using a code based on P, and when using a code based on Q. Typically P represents the “true” distribution of data, observations, or a precise calculated theoretical distribution. The measure Q typically represents a theory, model, description, or approximation of P. The chi-square distribution (also chi-squared or χ² distribution) is one theoretical probability distribution in inferential statistics, e.g., in statistical significance tests. It is useful because, under reasonable assumptions, easily calculated quantities can be proven to have distributions that approximate to the chi-square distribution if the null hypothesis is true. If Xᵢ are k independent, normally distributed random variables with mean 0 and variance 1, then the random variable

$$Q = {\sum }_{i = 1}^{k} {X}_{i}^{2}$$

is distributed according to the chi-square distribution. This is usually written

Q˜χₖ².

The chi-square distribution has one parameter: k—a positive integer that specifies the number of degrees of freedom (e.g. the number of Xᵢ).

Any sub-process for determining the distance between distributions (d_{E}) may be utilized instead of or in addition to Kullback-Leibler divergence and chi-squared error. For example, the method of moments with only the first moment may be utilized at 302. The method of moments is a way of proving convergence in distribution by proving convergence of a sequence of moment sequences. The first moment may be the mean. Thus, 1-norm of difference between the average colors in RGB space is used to distance between distributions. This may be noted as:

d_{D}(i,j):=distance between distributions=∥fᵢ−fⱼ∥₁

When two regions are merged, the merged region may have a different standard deviation than the sum of standard deviations of the two original regions. Let R₁ and R₂ be the two respective regions. Energy of a region may be noted as follows:

$$E = {\sum }_{i ∈ R} {( {x}_{i} - μ )}^{2} = n {μ}^{2} - 2 {μ}^{2} n + {\sum }_{i ∈ R} {x}_{i}^{2} = {\sum }_{i ∈ R} {x}_{i}^{2} - n {μ}^{2}$$

where, for simplicity,
xᵢ=scalar pixel intensity
μ=mean intensity of region R
n=number of pixels in region R

$$\begin{matrix}{E}_{{R}_{1} ⋃ {R}_{2}} - {E}_{{R}_{1}} - {E}_{{R}_{2}} = {\sum }_{i ∈ {R}_{1} ⋃ {R}_{2}} {( {x}_{i} - {μ}_{1 ⋃ 2} )}^{2} - {\sum }_{i ∈ {R}_{1}} {( {x}_{i} - {μ}_{1} )}^{2} - \\ {\sum }_{i ∈ {R}_{2}} {( {x}_{i} - {μ}_{2} )}^{2} - \\ = [ {\sum }_{i ∈ {R}_{1} ⋃ {R}_{2}} {x}_{i}^{2} - {\sum }_{i ∈ {R}_{1}} {x}_{i}^{2} - {\sum }_{i ∈ {R}_{2}} {x}_{i}^{2} - ] + \\ {n}_{1} {μ}_{1}^{2} + {n}_{2} {μ}_{2}^{2} - ( {n}_{1} + {n}_{2} ) {μ}_{1 ⋃ 2}^{2} \\ = 0 + {n}_{1} {μ}_{1}^{2} + {n}_{2} {μ}_{2}^{2} - {( {n}_{1} + {n}_{2} ) [ \frac{{n}_{1} {μ}_{1} + {n}_{2} {μ}_{2}}{{n}_{1} + {n}_{2}} ]}^{2} \\ = \frac{{n}_{1} {n}_{2}}{{n}_{1} + {n}_{2}} {( {μ}_{1} - {μ}_{2} )}^{2}\end{matrix}$$

Since ∥μ₁−μ₂∥ may resemble d_{D}(1,2) if using 2-norm, change in energy may be described due to the merge by the equation:

$$Δ E ( i , j ) := \frac{{n}_{i} {n}_{j}}{{n}_{i} + {n}_{j}} {d}_{D}^{2} ( i , j )$$

Thus, cost of merging regions i,j may be defined as:

$${d}_{E} ( i , j ) := \frac{{n}_{i} {n}_{j}}{{n}_{i} + {n}_{j}} {d}_{D}^{2} ( i , j ) .$$

The decision as to whether to merge two regions may be decided, entirely or in part, by determining the effective cost of the merger 303. To derive effective cost (d_{eff}) 303, a decision rule on a linear of combination of the distance between distribution (d_{D}) and the cost of merging regions (d_{E}) is utilized in some embodiments. Distribution and energy cost functions are combined through a relaxation parameter βₖ as follows:

d_{eff}(i,j)=(1−βₖ)·d_{E}(i,j)+βₖ·d_{D}(i,j).

βₖ depends on iteration k. One may choose βₖ such that it changes linearly from 0 to 1 from the first to the last iteration. The number of iterations is chosen to be a constant in some embodiments. For example, the number of iterations may be three. In other embodiments, the number of iterations is anywhere between two and one hundred or greater. It may be noted that that during the first iteration, only the cost due to change in energy is used and during the last iteration, only the cost due to difference in distribution is used.

Once the combined distance is evaluated, it is then compared with a threshold γ^{eff}ₖ, which again depends on the iteration number. It may be chosen so that it decreases linearly from 0.2 to 0.1. Regions may not be merged if the effective cost d_{eff}(i,j) exceeds this threshold γ^{eff}ₖ.

As desired, if the effective cost does not exceed the threshold, an additional cost function may be utilized to determine whether regions should be merged. For example, merging of regions that have a sharp boundary may, as desired, be discouraged. If the effective cost does not exceed the threshold, cost based on boundary energy may be derived 304. Optionally, the cost based on boundary energy may be inputted, determined, or provided. An example of a cost function for boundary energy is as follows:

$$\begin{matrix}{d}_{B} ( i , j ) = cost based on boundary energy \\ = Max Of ( boundary strength between regions i and j .\end{matrix}$$

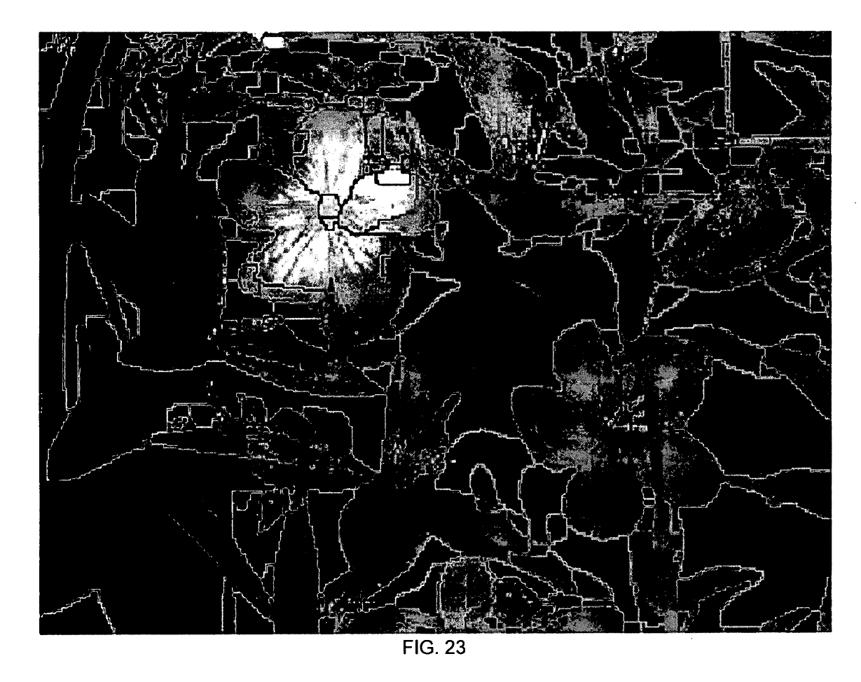

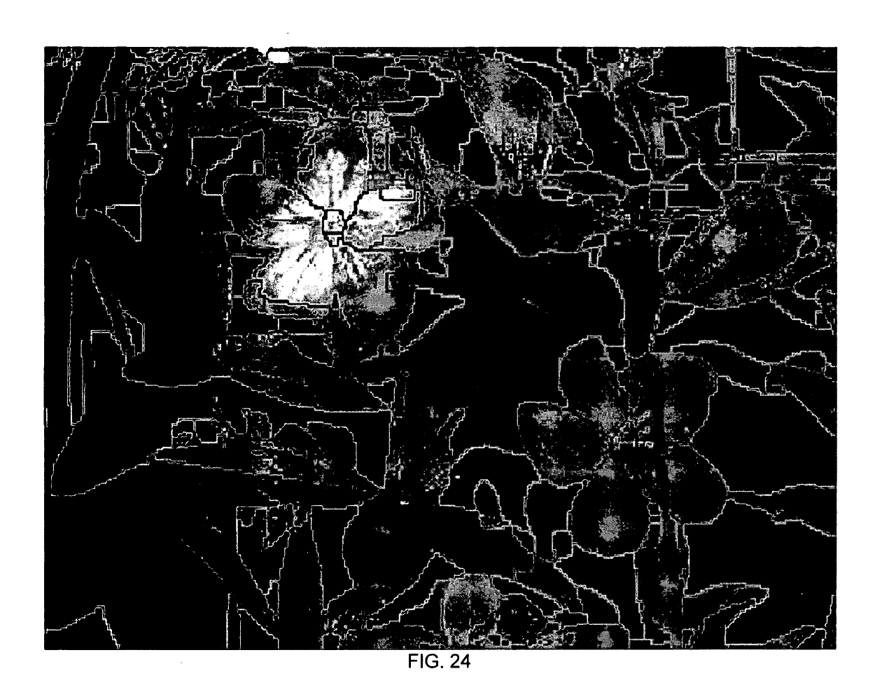

A similar threshold γ^{B}ₖ may be used for d_{B}. This threshold can be chosen so that it decreases linearly from 0.7 to 0.5 as k varies. Thus, the decision to merge the regions may be determined based on if the cost based on boundary energy does not exceed a threshold 305. As mentioned above, agglomeration or the merging of regions based on similarity 102 can be viewed as a step that transverses the scale space in the coarser direction. In other words, there are different levels of coarseness of JigCut regions. Agglomeration may be an iterative procedure. It merges JigCut regions to their neighboring JigCut regions if they satisfy certain similarity criteria. Thus, in such embodiments, 102 is iterated and each iteration of 102 produces a set of JigCut regions, a partition, at certain coarseness. As more regions are merged, the coarseness increases. FIG. 23 is the exemplary resulting image of FIG. 22 after agglomerating neighboring regions based on similarity at a lower level of coarseness. FIG. 24 is the exemplary resulting image of FIG. 22 after agglomerating neighboring regions based on similarity at a higher level of coarseness. FIG. 25 is the exemplary resulting image of FIG. 24 after the average color within each region is filled within each respective region.

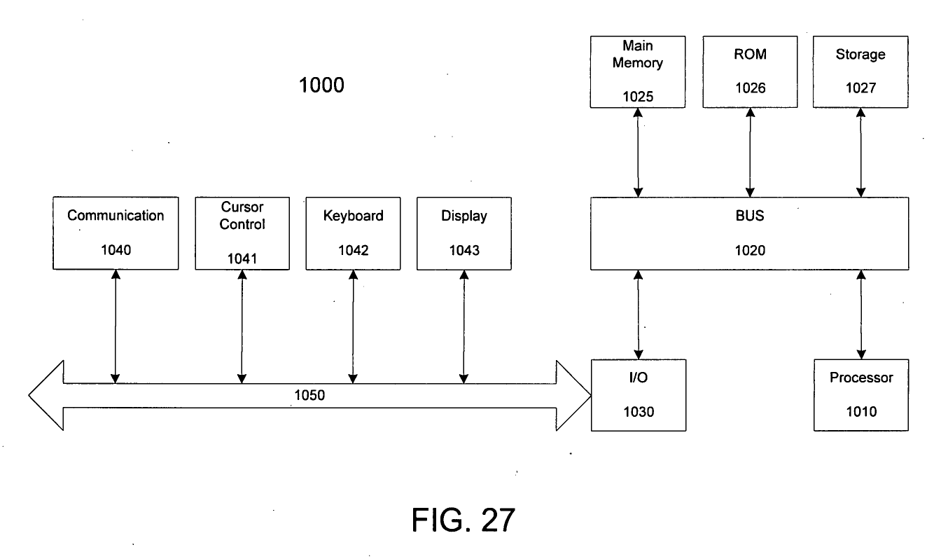

FIG. 27 is an illustration of an exemplary computer architecture for use with the present system, according to one embodiment. Computer architecture 1000 is used to implement the computer systems or image processing systems described in various embodiments of the invention. One aspect of the present disclosure provides a computer system, such as exemplary computer architecture 1000, for implementing any of the methods disclosed herein. One embodiment of architecture 1000 comprises a system bus 1020 for communicating information, and a processor 1010 coupled to bus 1020 for processing information. Architecture 1000 further comprises a random access memory (RAM) or other dynamic storage device 1025 (referred to herein as main memory), coupled to bus 1020 for storing information and instructions to be executed by processor 1010. Main memory 1025 is used to store temporary variables or other intermediate information during execution of instructions by processor 1010. Architecture 1000 includes a read only memory (ROM) and/or other static storage device 1026 coupled to bus 1020 for storing static information and instructions used by processor 1010.

A data storage device 1027 such as a magnetic disk or optical disk and its corresponding drive is coupled to computer system 1000 for storing information and instructions. Architecture 1000 is coupled to a second I/O bus 1050 via an I/O interface 1030. A plurality of I/O devices may be coupled to I/O bus 1050, including a display device 1043, an input device (e.g., an alphanumeric input device 1042 and/or a cursor control device 1041).

The communication device 1040 is for accessing other computers (servers or clients) via a network. The communication device 1040 may comprise a modem, a network interface card, a wireless network interface, or other well known interface device, such as those used for coupling to Ethernet, token ring, or other types of networks.

The disclosure is susceptible to various modifications and alternative forms, and specific examples thereof have been shown by way of example in the drawings and are herein described in detail. It should be understood, however, that the disclosure is not to be limited to the particular forms or methods disclosed, but to the contrary, the disclosure is to cover all modifications, equivalents, and alternatives. In particular, it is contemplated that functional implementation of the disclosed embodiments described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of the disclosed embodiments not be limited by this detailed description, but rather by the claims following.

What is claimed is:

1. A method for segmenting an image into a plurality of regions, each respective region in the plurality of regions comprising a plurality of pixels that are coherent in the respective region, the method comprising:
(A) applying a watershed transform to an edge strength map of the image thereby defining a plurality of candidate regions; and
(B) merging neighboring candidate regions in the plurality of candidate regions based on similarity of candidate regions in the plurality of candidate regions to thereby obtain the plurality of regions.

2. The method of claim 1, wherein the method further comprises gathering the edge strength map from the image before the applying (A).

3. The method of claim 2, wherein the gathering comprises:
extracting information for each channel in a plurality of channels from the image; and
applying an edge operator to the information in each channel in the plurality of channels.

4. The method of claim 1, wherein the merging (B) comprises determining whether to merge a first candidate region and a second candidate region in the plurality of candidate regions based upon a cost associated with the first candidate region and the second candidate region.

5. The method of claim 1, the method further comprising:
communicating the plurality of regions to a user, a computer readable storage medium, a monitor, or a computer that is part of a network; or displaying the plurality of regions.

6. The method of claim 1, the method further comprising resolving a plurality of boundaries between the plurality of regions.

7. The method of claim 6, the method further comprising:
communicating the plurality of boundaries to a user in a user readable format, a computer readable storage medium, a monitor, or a computer that is part of a network; or displaying the plurality of boundaries.

8. The method of claim 1, wherein the applying (A) and the merging (B) are performed using a suitably programmed computer.

9. A computer program product suitable for storage on a physical storage medium and having computer-readable instructions, the computer program product comprising computer executable instructions for:
(A) applying a watershed transform to an edge strength map of the image thereby defining a plurality of candidate regions; and
(B) merging neighboring candidate regions in the plurality of candidate regions based on similarity of candidate regions in the plurality of candidate regions to thereby obtain the plurality of regions.

10. The computer program product of claim 9, wherein computer program product further comprises instructions for communicating the plurality of regions to a user in a user readable format, a computer readable storage medium, a monitor, or a computer that is part of a network; or displaying the plurality of regions.

11. A computer system comprising:
one or more processing units;
a memory, coupled to the one or more processing units, the memory storing instructions executable by the one or more processing units for:
(A) applying a watershed transform to the image thereby defining a plurality of candidate regions; and
(B) merging neighboring candidate regions in the plurality of candidate regions based on similarity of candidate regions in the plurality of candidate regions to thereby obtain the plurality of regions.

12. The computer system of claim 11, further comprising instructions for communicating the plurality of regions to a user in a user readable format, a computer readable storage medium, a monitor, or a computer that is part of a network; or displaying the plurality of regions.
